(19) United States
(12) Patent Application Publication
(10) Pub. No.: US 2017/0178024 A1
(43) Pub. Date: Jun. 22, 2017

(54) UNSUPERVISED PERSONALIZATION SERVICE BASED ON SUBJECT SIMILARITY MODELING

(71) Applicant: Luis S. Kida, Beaverton, OR (US)

(72) Inventor: Luis S. Kida, Beaverton, OR (US)

(21) Appl. No.: 14/978,473

(22) Filed: Dec. 22, 2015

(51) Int. Cl. G06N 99/00; H04W 4/00; H04B 1/3827

(52) U.S. Cl. CPC G06N 99/005; H04B 1/385; H04W 4/005

(57) ABSTRACT

Embodiments of a system and method for creating a personalized model are generally described herein. A method may include receiving a series of measurements from a device, comparing stored measurements to the series of measurements at a predefined feature to determine a subset of the stored measurements, the subset of the stored measurements matching the series of measurements within a tolerance margin, and building a personalized model for the device using the subset of the stored measurements. A method may include iteratively building increasingly accurate personalized models with received data.

### BACKGROUND

A large class of devices, such as wearable devices, have insufficient computational resources to run complex models. These resource constrained devices are limited to less accurate models that infer simpler information. One solution to the problem is to develop multiple simple models that infer sophisticated information by restricting the models to be accurate only to a subset of the population with similar characteristics. Each resource constrained device runs one of these models that fits the resources of the device and the user of the device. The models described above are not capable of being applied broadly because the non-recurring engineering needed to develop new models that fit the individual devices is costly. The consequence of these problems is that current applications running in resource constrained devices are not accurate and only infer simple information.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a personalization training system in accordance with some embodiments.

FIG. 2 illustrates a graph showing sensor data from a population in accordance with some embodiments.

FIG. 3 illustrates a graph showing sensor data from an individual source in accordance with some embodiments.

FIG. 4 illustrates feature matching of measurement data in a graph in accordance with some embodiments.

FIG. 5 illustrates a flowchart showing a technique for creating a personalized model in accordance with some embodiments.

FIG. 6 illustrates generally an example of a block diagram of a machine upon which any one or more of the techniques (e.g., methodologies) discussed herein may perform in accordance with some embodiments.

FIG. 7 illustrates a flowchart showing a technique for iteratively building increasingly accurate personalized models with received data in accordance with some embodiments.

FIG. 8 includes a flowchart showing a technique for determining features for predicating accuracy of a first data model on a second set of data in accordance with some embodiments.

### DETAILED DESCRIPTION

Systems and methods for creating a personalized model for a device are described herein. The personalized model may be automated and use reduced input from a target user and reduced input from a human developer by using machine learning and computational resources in the cloud. The system to create personalized models may have limited access to the target user that the personalized model is created for, and little or no input from a developer. The systems and methods to create a personalized model may leverage labeled data of other users. The labeled data may have been collected in a database for supplementing the target user's data to develop a model for the target user.

Current machine learning systems may find features and models that “generalize well,” and apply equally well to users (e.g., a particular user) in a population regardless of whether the data from the particular user was used in training. Current machine learning systems may avoid “over-fitting” a model by avoiding better performance modeling the subset of the population that was used for training then the subset of the population that was not used for training. The creation of a general model that doesn't over-fit is a difficult task, current machine learning systems may fail to create a general model that doesn't over-fit other than for the simplest problems or, the generalized model is complex and may not fit in a constrained device. A personalized model development system described herein may include a service to turn the traditionally negative “over-fitting” (e.g., generally, machine learning systems attempt to avoid “over-fitting”) on its head into a beneficial “customization” of the model for an individual subject in the population.

When there are shared common characteristics of data from users, the data from one user may be used to build a personalized model for another user with little loss of accuracy. Data from users that are different in these characteristics may build models that have a higher loss of accuracy. When the data available from a target user, for whom a customized model is to be built, is modeled well by a predetermined customized model for a previous user, such as a user with data already in a database, then the available data from the previous user may be similar to the yet unseen or unavailable data from the target user. Due to the potential similarity, the data from the previous user stored in the database may be used as a proxy to build a personalized model for the target user.

The development of a personalized model for a target user is a machine learning problem of finding features that identify data of the users in a database, where the data yields a model optimal for the target user, for whom the model is being built. An accuracy of the model for data of a target user may be used as the label for data from other users. The cross correlation of accuracy of personalized models to user's data sets (e.g., the accuracy of modeling of the target user's data set by a personalized model originally built for a different user or that did not use the target user's data) is used as labeled data. The labeled data is used to train a classifier to predict that the model customized to a previous user will be highly accurate on a target user's data. A previous user and the previous user's labeled data that was used to build the model with high accuracy for the target user's data are said to be similar to or “like” the target user and target user's data. The data and previous user or users having labeled data that were used to build a model of low accuracy are said to be dissimilar to or “unlike” the target user and target user's data. The development of the classifier using machine learning identifies features that classify, or cluster, the previous users as similar or dissimilar to the target user. When the feature is found, the feature may be used to classify previous users in a database as similar to a new target user for future personalization without comparing results of personalized models.

In an example, a method of identification of similar users may include testing a target user's data on all models of previous users to identify the similar previous users. When the unsupervised personalization system for an application has been developed, such as when the feature to classify users has been identified, the incremental cost to build a new personalized model is the compute time to run a modified traditional machine learning flow. The modified traditional machine learning flow includes calculating the feature for the new target user, finding the subset of previous users with features that cluster to the features of the new target user, composing a training set from data of the subset of previous users, training the personalized model, and validating the quality of the personalized model using the target user's data and data from the subset of previous users like the target user. The automated, low-cost platform to customize models enables a cloud service to improve models over time as more data from the target user is collected.

The operations to develop a service to generate personalized models that require use of a data scientist may be limited to determining which feature or features best separates users, and after the feature is determined, tracking the performance of the personalization service to validate the effectiveness of the service. The operations avoid using a data scientist to develop each personalized model. After the personalization service for an application has been developed, the incremental cost to build a new personalized model is the compute time to find data in the cloud of “like users,” build the training set, build the model, and validate the quality of the model. The amount of data that is collected from the target user may be limited to a sufficient amount to perform clustering with the labeled data of previous users, stored in the cloud for the purpose of developing models. The clustering may be performed with data labeled by the target user (i.e., self-reported) or with data labeled by an accurate model on the cloud. In another example, the clustering may be performed with unlabeled data to further reduce the burden on the target user. Unlike other approaches, labeled data from the target user may be collected in smaller quantities than those approaches that create a new model from scratch. The labeled data from the target user may use smaller quantities of data than those approaches that measure the accuracy against multiple models to “pick” a best fitting one. The service avoids picking a best fitting model by identifying features to use for clustering using previous users and data collected from the previous users to develop the service.

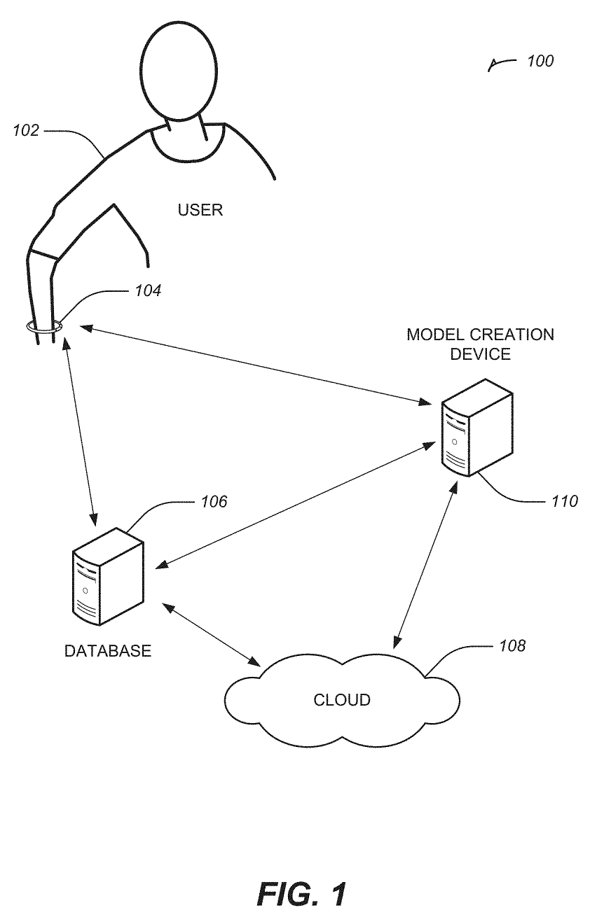

FIG. 1 illustrates a personalization training system 100 in accordance with some embodiments. The personalization training system 100 may include a user 102 with a wearable 104, a database 106, a cloud service 108, or a model creation device 110. In an example, the wearable device 104 may include a sensor for tracking biometric data. The biometric data may be modeled by a personalized model using techniques described herein. In another example, the system 100 may include a motor, engine, device, or system, the motor, engine, device, or system benefiting from a personalized model. In an example, the user 102 may include the motor, engine, device, or system. The example system 100 in FIG. 1 shows the model creation device 110, the cloud 108, and the database 106 as separate entities. In an example not shown, the model creation device 110 or the database 106 may be a part of the cloud 108. In another example not shown, the cloud 108 may be used to perform operations described herein as occurring at the model creation device 110. In yet another example, the cloud 108 and the database 106 may be interchangeable for storing data.

In an example, wearable devices for industrial or consumer sports and fitness applications may benefit from a personalized model. Wearable devices, such as wearable device 104 may have size or weight limitations that may restrict battery or computational power of the wearable device 104. The user 102 may represent one user out of a large population of users with high variability that may use the wearable device 104, making it difficult to implement a simple model that correctly interprets the sensor readings of the wearable device 104 to infer more than trivial information for all users. With the large variability in the population, the sensor readings from different individuals may be contradictory, that is, identical sensor readings may indicate one condition in one subject and a different condition in another subject. In these cases, modeling the condition for a diverse population containing contradictions may be infeasible. In another example, personalization of the model may take into account the device, subject, or environment of the device and user in the model. For example, the vibrations of a compressor motor of an air conditioner firmly attached to a cement floor may be compared to the vibrations of a motor (pump) on a wood platform or a fan supported in metal conduits in a forced air heating system.

The method to automate the creation of a personalized model may enable the implementation of a cloud service platform (e.g., using the cloud 108) to create increasingly improving customized models with minimal input from the user 102 or from an application developer. Sophisticated inferences that can still run on the resource constrained device 104 may be added to the personalization training system 100 that apply to a less diverse population of users “like” the user 102. The personalization training system 100 includes the wearable device 104 with a generic model with good enough accuracy (e.g., a model that covers a majority of users or a majority of use case) and sufficient inferences (e.g., in a heart monitor, determining when a heart rate is too high or too low) for market requirements. The wearable device 104 collects sensor data and may upload that data to a database 106. The database 106 may be connected with a cloud 108, or the database 106 may be a part of the cloud 108. In an example, the wearable device 104 may send device or user metadata to the database 106. In another example, user classification, if available, may be uploaded to the database 106. In the database 106 or the cloud 108, the unlabeled data is stored in a repository and available for visualization by the user 102 as a service. The user may opt-in to share the user's data for personalization and model development.

A highly accurate model may label the data from the user 102 without user interaction. Data labeled by the user 102 may be stored with a different confidence level on the label in the database 106. The data may be accessed by the model creation device 110, such as from the wearable device 104 directly, from the database 106, or from the cloud 108. The model creation device 100 may use a classification technique to identify users in the development database 106 that are similar to the user 102. The model creation device 100 may use a training set from data of users that are like the user 102 to train a customized model that fits within the resources of the wearable device 104. The customized model may be tested (e.g., at the model creation device 110), and if it is better than the current version of the model in the device (e.g., the generic model or a previously applied personalized model), the new model is downloaded to the wearable device 104 to deliver a superior accuracy and inferences. The new model may be a personalized model for the wearable device 104 or the user 102. In an example, the accuracy of an initial model may be worse than the higher end target accuracy demanded by customers as it will improve with customization. The initial model may meet the minimum accepted by the market, which may reduce the engineering effort to optimize a complex program to run in a resource constrained device, such as the wearable device 104.

One issue with consumer wearable devices is that a user's interest in the device wears off when the novelty of the information provided by the device dissipates. Some estimates indicate that one third of sports and fitness wearable devices are no longer worn 6 months after first use. As the amount of data from the wearable device 104 accumulates in the cloud data repository 108, sub-populations matching user 102 may be identified more accurately enabling further customization and refinement of the personalized model. In an example, a uniform sub-population of like subjects may enable modeling of more sophisticated applications that may be offered to the user 102 of the wearable device 104. The additional and sophisticated applications may help keep the information provided by the wearable device 104 new, and help keep the user 102 engaged.

When the model creation device 110 has access to a large or consistent population that is like the user 102 or the wearable device 104, additional sophisticated applications may be added to the wearable device 104. To run these applications in the resource constrained wearable device 104, the model creation device 110 may create a personalized model using the large or consistent population that is like the user 102 or the wearable device 104. In another example, a personalized model may be used that is easier to map to embedded firmware of the wearable device 104, which may reduce engineering effort. Improving services at the wearable device 104 may be used as an enticement for the user 102 to share data. The shared data may be used to develop other applications and for additional services based on data analytics.

In an example, a personalized model may promote a greater sense of personal attachment to the wearable device 104 for the user 102 than a model developed to fit a broad population. The user 102 may be less likely to replace the wearable device 104 when it uses the personalized model due to a personal attachment developed with the wearable device 104. The personal attachment may develop for the user 102 due to the time invested while data was collected and the personalized model was developed. The user 102 may be less likely to replace the wearable device 104 when the personalized model performance is superior to a generic model of a wearable device that does not include personalization services.

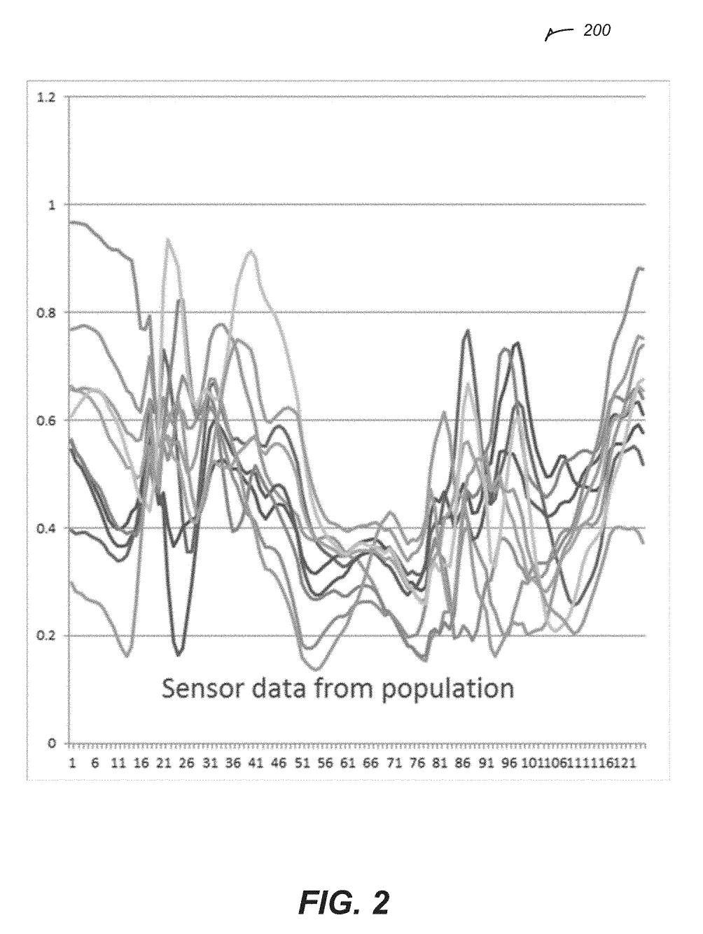

FIG. 2 illustrates a graph 200 showing sensor data from a population in accordance with some embodiments. The graph 200 illustrates how different devices or different users may have different sensor data. The graph 200 may indicate a similar phenomenon occurring across various devices, even though the data looks different. For example, graph 200 may represent accelerometer data from a wearable device. In another example, heart beat data from a wearable device may be similar to the graph 200. The heart beat data may differ for various devices, and may represent a single heart beat with different data values. In another example, a model that accurately models one of the sensor data streams shown in graph 200 may not accurately model another sensor data stream shown in graph 200. The accelerometer data shown in the graph 200 may represent similar movements by a plurality of users.

Some current approaches to develop personalized user applications on a consumer product have the customer collect and label large amounts of data to feed machine learning techniques that use large amounts of labeled data to train and test a model. This effort by the user may detract from the user experience of a model. The personalized model described herein reduces the burden on the user by leveraging data of other users already stored to create the personalized model.

A device may be initially activated with an application model that is not customized to a user, device, or environment. Periodically, the device may autonomously upload representative sensor data to the cloud. A feature extracted from the data may be used to identify other data from other users stored in the cloud that have similar characteristics. The data from the user combined with the data from the other users of similar characteristic may be used to develop a personalized model. The personalized model may be designed to improve accuracy for the specific user and to fit within the capabilities of the device. The personalized model may have accuracy comparable to a complex generic cloud model that is applicable to a wide population and be operable by the device (which may have constraints on battery usage, power, etc.). For example, the personalized model may apply to a group of users with a narrower range of characteristics. The personalized model may be downloaded to the device the next time the device connects to the cloud or according to user preferences.

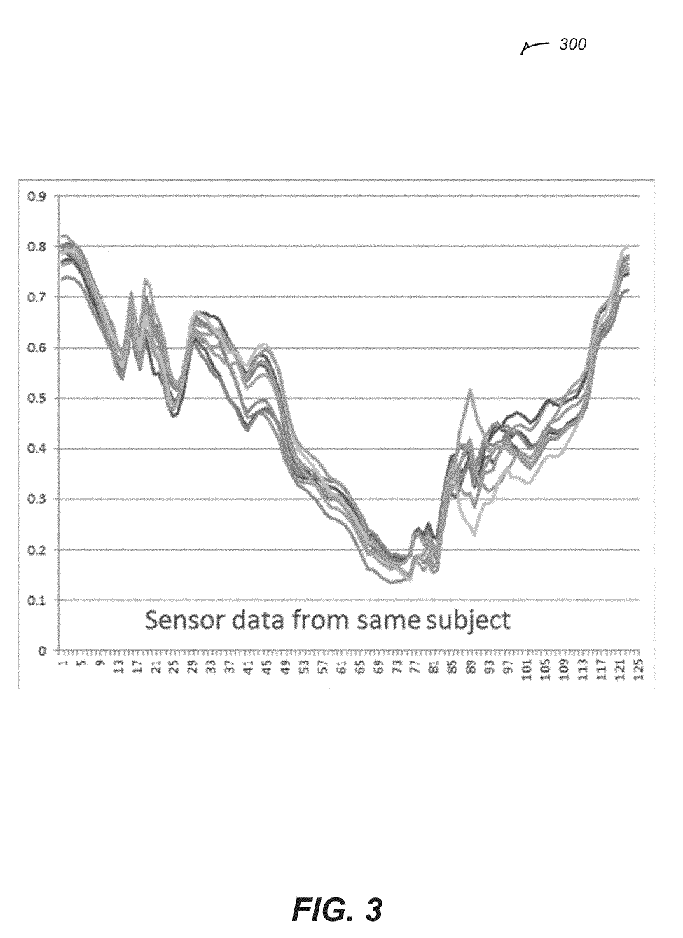

FIG. 3 illustrates a graph 300 showing sensor data from an individual source in accordance with some embodiments. While the graph 200 of FIG. 2 illustrates the variability of sensor data in a diverse population, the graph 300 of FIG. 3 illustrates more regular data from a single user or device. The graph 300 illustrates that a simpler, more accurate, or simpler and more accurate model may be used for a personalized model.

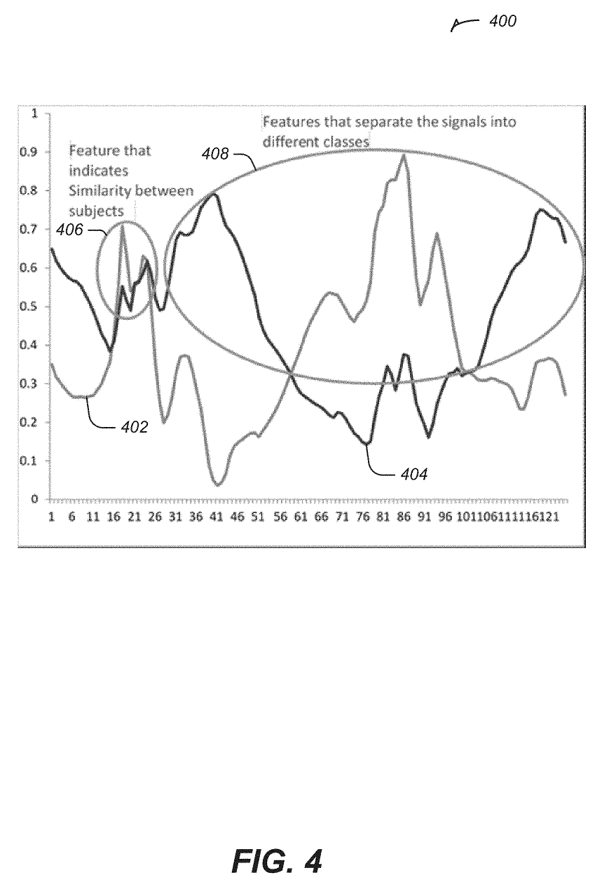

FIG. 4 illustrates measurement data in a graph 400 in accordance with some embodiments. The graph 400 shows a target series of measurements 402 and a stored series of measurements 404. In an example, a technique to determine a personalized model includes selecting data from other devices, such as data stored in a cloud service, which may be used to build the personalized model. For example, the target series of measurements 402 may be received from a target device, and the stored series of measurements 404 may be stored in a database. The stored series of measurements 404 may be used to build a personalized model for the target device.

The technique includes determining that the data from the target device is known and modeled well by a personalized model for the stored data device. The technique includes determining that data collected from the stored data device is similar to data collected from the target device under similar conditions. The data from the stored data device may be stored in the cloud and may be used to build a personalized model for the target device. The technique includes determining that there are features, also called characteristics, such as a first feature 406, that are common to the data from the target device and the stored data device. The similarities between the target device and the stored data device may be determined through techniques, such as machine learning techniques, to provide data to generate a model for the target device. The first feature 406 may indicate similarity between data from the target device or a target user using the target device, from which the target series of measurements 402 was collected and stored data from the stored data device or a stored user who used the stored data device, from which the stored set of measurements 404 was collected. For example, the target series of measurements 402 may vary from the stored series of measurements 404 at the first feature 406 by less than a tolerance margin, such as a predetermined margin of error.

The graph 400 illustrates the first feature 406 that indicates similarity between the target series of measurements 402 and the stored series of measurements 404. In an example, the graph 400 shows that the target series of measurements 402 and the stored series of measurements 404 may include a second feature 408 that indicates differences that may be used in classification of waveforms by the model. Similar techniques for the first feature similarities may be used on the differences in classification. A technique for developing a personalized model for the target series of measurements 402 may include finding the features, such as the first feature 406 that group systems based on a similarity of data from the systems (e.g., the target series of measurements 402 and the stored series of measurements 404). The features may be found by developing a classifier using a machine learning technique. The machine learning technique may find the features (e.g., the first feature 406) in the sensor data that show a best correlation of the target series of measurements 402 to a customized model for the stored series of measurements 404 at an expected accuracy of classification for the personalization model. For example, the machine learning technique may include using a linear discriminant analysis, a principal component analysis, or a predictor of similarities.

In an example, when a feature 406 exists because the feature is caused by two users with a left leg shorter than the right leg, the system may indicate that data from the user of the series of measurements 404 may be used to create a model for the user of the series of measurements 402, even though there are differences in the measurements as shown by the difference in feature 408. For example, a shape of the series of measurements 402 at the feature 408 may indicate a walk while a shape of the series of measurements 404 at the feature 408 may indicate a jump. The data from the series of measurements 404 may be used to train or teach a model how the user for the series of measurements 402 would jump. This training may be done because the feature 406 was used by the system to determine that both series of measurements 402 and 404 would have similar waveforms for jumping. This determination of similar waveforms is based on underlying physical characteristic of the users, devices, and measurements, which are not needed or used by the machine learning system. The machine learning system determines that the models matched well at feature 406, and from this information determines the future usefulness of the second series of measurements 404 in modeling an underlying activity to be done at a first device corresponding to the first series of measurements.

The table below illustrates an example of the type of information that may be used as input to a machine learning algorithm to create a personalized model. Table 1, below, details how accurately (percent correct) data from one user, or from a mix of users that represent the general population, is classified correctly by the model personalized to a target user or to a model designed to model the general population.

TABLE 1
Accuracy in Personalized Models

| | | |
|---|---|---|
| Accuracy | Personalized model for: | General |

| Test set from: | Peter | Paul | Sam | Mary | Model |
|---|---|---|---|---|---|
| Peter | 0.89 | 0.85 | 0.65 | 0.60 | 0.75 |
| Paul | 0.84 | 0.87 | 0.68 | 0.75 | 0.70 |
| Sam | 0.65 | 0.62 | 0.86 | 0.72 | 0.68 |
| Mary | 0.59 | 0.66 | 0.71 | 0.88 | 0.72 |
| Population | 0.68 | 0.67 | 0.65 | 0.64 | 0.78 |

In an example, a feature may be selected that indicates that the data used to build a personalized model for Paul may be useful in building a personalized model for Peter because the data from Peter was correctly classified by the model for Paul 85% of the time. (e.g., 0.85 cell in Table 1). After identifying the feature, the feature may be used to determine whether the data of other users is useful in building the personalized model for Peter. The feature may be used to classify other users in the database as similar to a new subject Mark without having to build more personalized models or run tests on the existing personalized models. The feature (or feature vector) value may be calculated for Mark, and compared to the feature values for the users in the database. The degree of similarity between the users may be estimated by the difference (e.g., distance) between Mark's feature and the feature of the other subjects. For example, Table 2 below shows distances to Mark's feature to classify similarity of users.

TABLE 2
Distances to a User's Feature

| User | Feature value | Distance to Mark |
|---|---|---|
| Peter | 98 | 48 |
| Paul | 100 | 50 |
| Sam | 45 | 5 |
| Mary | 150 | 100 |
| Mark | 50 | 0 |
| Population | 110 | 60 |

In Table 2, the feature value calculated for Mark is F(Mark)=50, and the distance to Mark's own feature value is zero, since Mark is a perfect match to Mark. The feature may predict that the population model does not match Mark's data as well as the model built for Sam because the distance to the population is larger than the distance to Sam. Sam's data in the database may be the most similar to data from Mark and the best suited to build a personalized model for Mark in the absence of data from Mark. Sam's data is not compared directly to Mark's data. Instead, the feature aggregates all the information pertaining to similarity and the system may calculate and compare feature values without having to compare data directly. Sam's data may be tested on the personalized model of Mark and Mark's data may be tested on the personalized model of Sam, to validate the use of Sam's data as a proxy for Mark's unknown data. In an example, the personalized model of Sam may be selected as Mark's model. In this example, the customization may select a best fit model from available pre-trained models, the best fit based on the available data from Mark. In another example, a new model may be trained with training data from Mark, Sam, or other subjects based on a desired similarity or tolerance margin and based on the amount of data desired for training. The number of users and dissimilarity tolerance level of the user's data aggregated to train a new model may be based on the desired amount of data for training and desired accuracy for the model.

A personalized model for Mark may be validated with a test set of Mark's data (such as by using the available data, or a subset of the available data). The personalized model may be cross checked with test data from the users that provided data for training the personalized model as well, such as to confirm that the accuracy of the personalized model is better than a current model.

The data used for matching to Mark's data is collected in advance. For example, a manufacturer or designer of a device may record detailed data of the device in different states (e.g., functioning, malfunctioning, operating on a left hand or on a right hand, running at different temperatures, etc.). The recorded data may be modeled and saved in a database for later comparison with Mark's data. The models may be used to predetermine a feature. The feature may be used to compare Mark's data to the recorded data to determine a subset of the recorded data within a tolerance margin. The subset of the recorded data may be used to create a model for Mark. The data collected by Mark for the creation of a personalized a model may be small, only sufficient for determining similarity to the recorded data stored in the system that was collected ahead of time.

The personalized model may be used to monitor a corresponding device. For example, the device may be monitored using the personalized model to determine whether the device is operating within normal operating parameters for that device. For example, if a motor starts to break down or pipes have a leak, the notification may indicate an error when the personalized model indicates that the motor or pipe is operating outside of a normal operating procedure for that device (e.g., is broken). In another example, the notification may indicate that a device is operating normally for that device. In yet another example, the notification may be used to indicate a current status of a device when operating normally for that device. For example, if the device is a wearable device, such as a heart rate monitor, the notification may indicate a status, such as a current heart rate. Other notifications may include a device status, such as a warning that a device is approaching a dangerous situation for that user. In another example, a notification may offer recommendations to correct device operations for that specific device, such as to place the device within a tolerance margin specific to that device.

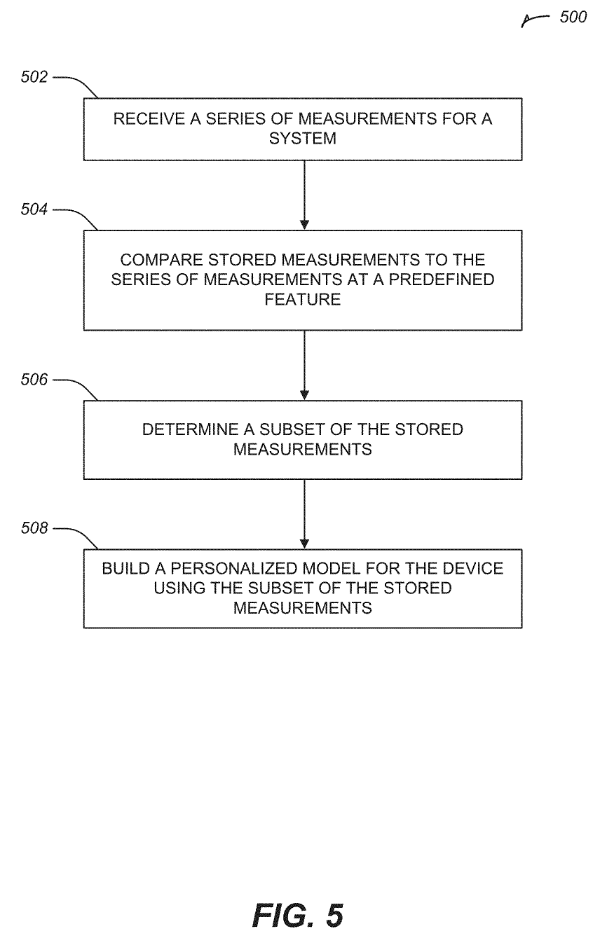

FIG. 5 illustrates a flowchart showing a technique 500 for creating a personalized model in accordance with some embodiments. The technique 500 includes an operation 502 to receive, at a server, a series of measurements from a device. The series of measurements may be received from a wearable device that uses a sensor to take the series of measurements.

The technique 500 includes an operation 504 to compare stored measurements to the series of measurements at a predefined feature. The predefined feature may be determined using the stored measurements. For example, the stored measurements may be used to create a plurality of models, such as a plurality of models corresponding to a plurality of devices used to create the stored measurements. The predefined feature may be determined by comparing the plurality of models using machine learning.

The technique 500 includes an operation 506 to determine a subset of the stored measurements. The subset of the stored measurements may be determined by matching the stored measurements to the series of measurements within a tolerance margin, such as in the comparison of operation 504. The technique 500 includes an operation 508 to build a personalized model for the device using the subset of the stored measurements. The operation 508 may include using the series of measurements to build the personalized model. In an example, the technique 500 includes using the series of measurements to validate the personalized model. In an example, the wearable device 104 of FIG. 1 may be the device of the technique 500. The series of measurements may include biometric sensor measurements, such as heart rate measurements, blood pressure measurements, skin conductance measurements, or the like.

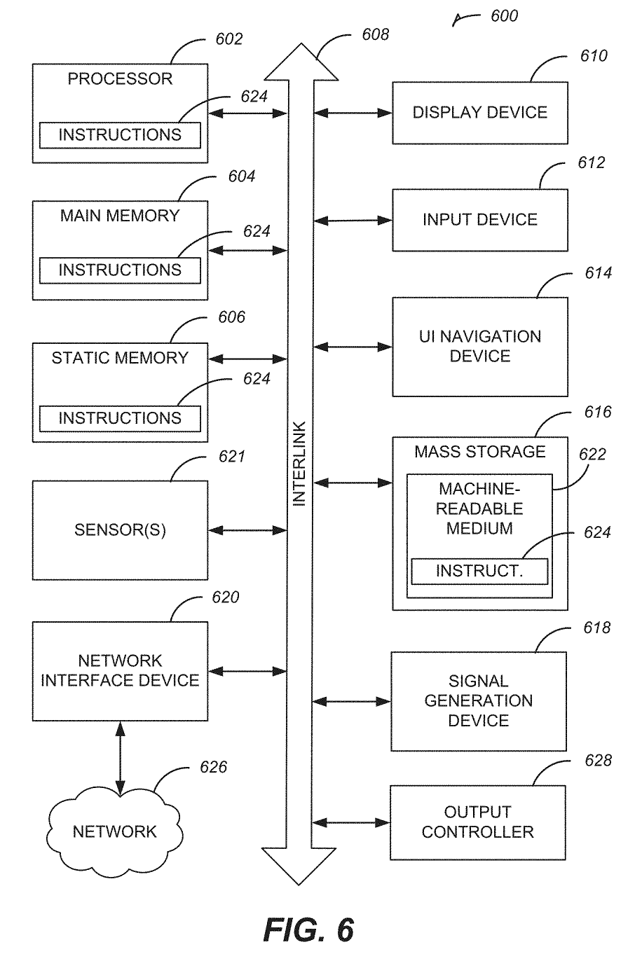

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

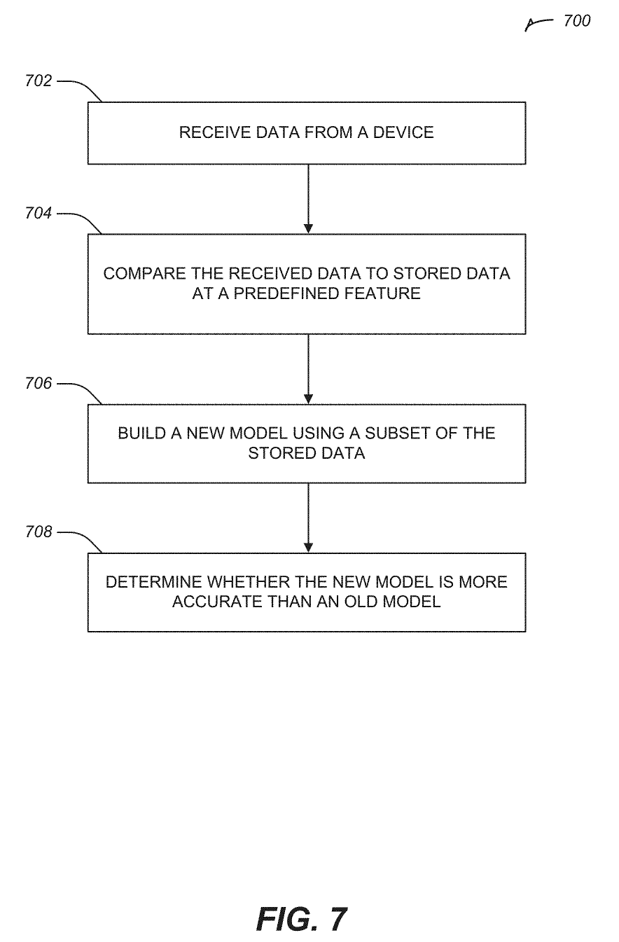

FIG. 7 illustrates a flowchart showing a technique 700 for iteratively building increasingly accurate personalized models with received data in accordance with some embodiments. The technique 700 includes an operation 702 to receive data from a device. The technique 700 includes an operation 704 to compare the received data to stored data at a predefined feature. The technique 700 includes an operation 706 to build a new model using a subset of the stored data. The technique 700 includes an operation 708 to determine whether the new model is more accurate than an old model, such as an old model currently running on the device. When operation 708 determines that the new model is more accurate than the old model, the technique 700 includes replacing the old model with the new model, such as by sending the new model to the device. The technique 700 may be iterated when additional data is received from a device, such as at predetermined intervals (e.g., daily, weekly, etc.) or when sufficient additional data is received.

In an example, the technique 700 may determine whether the new model is more accurate than the old model by using the received data as test data. For example, the new model more closely follows the receive data than the old model when an average error or cumulative error is less for the new model than the old model. In another example, a portion of the stored measurements may be used to determine that the new model is more accurate than the old model.

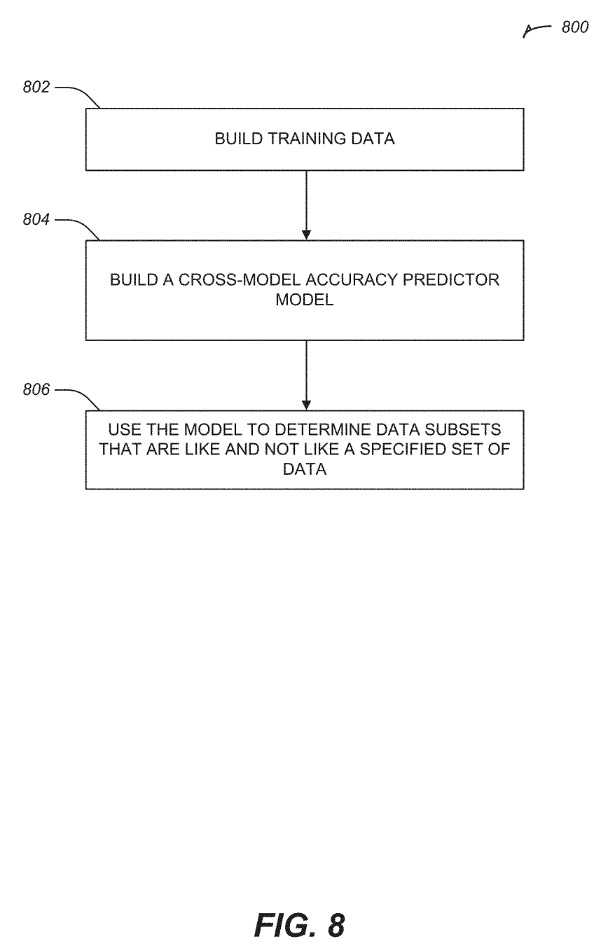

FIG. 8 includes a flowchart showing a technique 800 for determining features for predicting accuracy of a first data model on a second set of data in accordance with some embodiments. The technique 800 includes an operation 802 to build training data. Building training data may include creating personalized models for a sub-population of data, the sub-population representative of a population to build models for, using the personalization system. The operation 802 may include collecting data from each user (or device) in the sub-population, creating a model for each user using data from the user (or from the user's device), and creating a cross-model accuracy table.

The technique 800 includes an operation 804 to build a cross-model accuracy predictor model. The cross-model accuracy table may be used to build the cross-model accuracy predictor model. A machine learning algorithm may be used to find a model that maps data from two different users, for example user A and user B, to determine a predicted accuracy of using a model generated with user B's data for data from user A. The technique 800 may use a feature of the model to map a distance between the features of data from A and data from B to predict that user or device A is like user or device B.

The technique 800 includes an operation 806 to use the model to determine data subsets that are “like” and “not like” a specified set of data for a specified user. For example, the operation 806 may pick which users (and user's data sets) are “like” and “not like” the specified user (and the specified user's set of data). For example, the technique 800 may include calculating a feature of data set A (F(A)), and calculating a distance of F(A) to the F(data sets in a database). The technique 800 may then determine users/data that are close enough (e.g., within a margin), such as determining whether F(A)−F(B)<threshold. When F(A)−F(B)<threshold, the data set B or user B may be identified as the data subset or user “like” data set A or user A.

### Various Notes & Examples

Each of these non-limiting examples may stand on its own, or may be combined in various permutations or combinations with one or more of the other examples.

Example 1 is a system for creating a personalized model, the system comprising: processing circuitry to: receive a series of measurements from a device; compare stored measurements to the series of measurements at a predefined feature to determine a subset of the stored measurements, the subset of the stored measurements matching the series of measurements within a tolerance margin; and build a personalized model for the device using the subset of the stored measurements.

In Example 2, the subject matter of Example 1 optionally includes, wherein to build the personalized model, the processing circuitry is to use the series of measurements.

In Example 3, the subject matter of any one or more of Examples 1-2 optionally include, wherein the processing circuitry is to validate the personalized model using the series of measurements.

In Example 4, the subject matter of any one or more of Examples 1-3 optionally include, wherein the processing circuitry is to determine the predefined feature using the stored measurements.

In Example 5, the subject matter of Example 4 optionally includes, wherein the processing circuitry is to create a plurality of models corresponding to devices used to generate the stored measurements, and wherein to determine the predefined feature includes using the plurality of models.

In Example 6, the subject matter of any one or more of Examples 1-5 optionally include, wherein the processing circuitry is to send the personalized model to the device.

In Example 7, the subject matter of any one or more of Examples 1-6 optionally include, wherein the processing circuitry is to: receive a second series of measurements from the device; compare the stored measurements to a combination of the series of measurements and the second series of measurements at the predefined feature to determine a second subset of the stored measurements; and build a second personalized model using the second subset of the stored measurements.

In Example 8, the subject matter of Example 7 optionally includes, wherein the processing circuitry is to determine that the second personalized model is more accurate than the personalized model, and send the second personalized model to the device to replace the personalized model.

In Example 9, the subject matter of any one or more of Examples 7-8 optionally include, wherein the processing circuitry is to iteratively receive measurements from the device, compare the stored measurements to received measurements, build a new personalized model, and send the new personalized model to the device to replace a previous personalized model when the new personalized model is more accurate than the previous personalized model.

In Example 10, the subject matter of any one or more of Examples 1-9 optionally include, wherein the device is a wearable device.

In Example 11, the subject matter of any one or more of Examples 1-10 optionally include, wherein the series of measurements include biometric sensor measurements.

Example 12 is a method for creating a personalized model, the method comprising: receiving, at a server, a series of measurements from a device; comparing stored measurements to the series of measurements at a predefined feature to determine a subset of the stored measurements, the subset of the stored measurements matching the series of measurements within a tolerance margin, and building a personalized model for the device using the subset of the stored measurements.

In Example 13, the subject matter of Example 12 optionally includes, wherein building the personalized model includes using the series of measurements.

In Example 14, the subject matter of any one or more of Examples 12-13 optionally include, further comprising validating the personalized model using the series of measurements.

In Example 15, the subject matter of any one or more of Examples 12-14 optionally include, further comprising determining the predefined feature using the stored measurements.

In Example 16, the subject matter of Example 15 optionally includes, further comprising creating a plurality of models corresponding to devices used to generate the stored measurements, and wherein determining the predefined feature includes using the plurality of models.

In Example 17, the subject matter of any one or more of Examples 12-16 optionally include, further comprising sending the personalized model to the device.

In Example 18, the subject matter of any one or more of Examples 12-17 optionally include, further comprising: receiving a second series of measurements from the device; comparing the stored measurements to a combination of the series of measurements and the second series of measurements at the predefined feature to determine a second subset of the stored measurements; and building a second personalized model using the second subset of the stored measurements.

In Example 19, the subject matter of Example 18 optionally includes, further comprising determining that the second personalized model is more accurate than the personalized model, and sending the second personalized model to the device to replace the personalized model.

In Example 20, the subject matter of any one or more of Examples 18-19 optionally include, further comprising iteratively receiving measurements from the device, comparing the stored measurements to received measurements, building a new personalized model, and sending the new personalized model to the device to replace a previous personalized model, when the new personalized model is more accurate than the previous personalized model.

In Example 21, the subject matter of any one or more of Examples 12-20 optionally include, wherein the device is a wearable device.

In Example 22, the subject matter of any one or more of Examples 12-21 optionally include, wherein the series of measurements include biometric sensor measurements.

Example 23 is at least one machine-readable medium including instructions for operation of a computing system, which when executed by a machine, cause the machine to perform operations of any of the methods of Examples 12-22.

Example 24 is an apparatus comprising means for performing any of the methods of Examples 12-22.

Example 25 is at least one machine-readable medium including instructions for operation of a computing system, which when executed by a machine, cause the machine to perform operations comprising: receiving a series of measurements from a device; comparing stored measurements to the series of measurements at a predefined feature to determine a subset of the stored measurements, the subset of the stored measurements matching the series of measurements within a tolerance margin; and building a personalized model for the device using the subset of the stored measurements.

In Example 26, the subject matter of Example 25 optionally includes, wherein building the personalized model includes using the series of measurements.

In Example 27, the subject matter of any one or more of Examples 25-26 optionally include, further comprising validating the personalized model using the series of measurements.

In Example 28, the subject matter of any one or more of Examples 25-27 optionally include, further comprising determining the predefined feature using the stored measurements.

In Example 29, the subject matter of Example 28 optionally includes, further comprising creating a plurality of models corresponding to devices used to generate the stored measurements, and wherein determining the predefined feature includes using the plurality of models.

In Example 30, the subject matter of any one or more of Examples 25-29 optionally include, further comprising sending the personalized model to the device.

In Example 31, the subject matter of any one or more of Examples 25-30 optionally include, further comprising: receiving a second series of measurements from the device; comparing the stored measurements to a combination of the series of measurements and the second series of measurements at the predefined feature to determine a second subset of the stored measurements; and building a second personalized model using the second subset of the stored measurements.

In Example 32, the subject matter of Example 31 optionally includes, further comprising determining that the second personalized model is more accurate than the personalized model, and sending the second personalized model to the device to replace the personalized model.

In Example 33, the subject matter of any one or more of Examples 31-32 optionally include, further comprising iteratively receiving measurements from the device, comparing the stored measurements to received measurements, building a new personalized model, and sending the new personalized model to the device to replace a previous personalized model, when the new personalized model is more accurate than the previous personalized model.

In Example 34, the subject matter of any one or more of Examples 25-33 optionally include, wherein the device is a wearable device.

In Example 35, the subject matter of any one or more of Examples 25-34 optionally include, wherein the series of measurements include biometric sensor measurements.

Example 36 is an apparatus for creating a personalized model, the apparatus comprising: means for receiving a series of measurements from a device; means for comparing stored measurements to the series of measurements at a predefined feature to determine a subset of the stored measurements, the subset of the stored measurements matching the series of measurements within a tolerance margin; and means for building a personalized model for the device using the subset of the stored measurements.

In Example 37, the subject matter of Example 36 optionally includes, wherein the means for building the personalized model include means for using the series of measurements.

In Example 38, the subject matter of any one or more of Examples 36-37 optionally include, further comprising means for validating the personalized model using the series of measurements.

In Example 39, the subject matter of any one or more of Examples 36-38 optionally include, further comprising means for determining the predefined feature using the stored measurements.

In Example 40, the subject matter of Example 39 optionally includes, further comprising means for creating a plurality of models corresponding to devices used to generate the stored measurements, and wherein the means for determining the predefined feature include means for using the plurality of models.

In Example 41, the subject matter of any one or more of Examples 36-40 optionally include, further comprising means for sending the personalized model to the device.

In Example 42, the subject matter of any one or more of Examples 36-41 optionally include, further comprising: means for receiving a second series of measurements from the device; means for comparing the stored measurements to a combination of the series of measurements and the second series of measurements at the predefined feature to determine a second subset of the stored measurements; and means for building a second personalized model using the second subset of the stored measurements.

In Example 43, the subject matter of Example 42 optionally includes, further comprising means for determining that the second personalized model is more accurate than the personalized model, and means for sending the second personalized model to the device to replace the personalized model.

In Example 44, the subject matter of any one or more of Examples 42-43 optionally include, further comprising means for iteratively receiving measurements from the device, comparing the stored measurements to received measurements, building a new personalized model, and sending the new personalized model to the device to replace a previous personalized model, when the new personalized model is more accurate than the previous personalized model.

In Example 45, the subject matter of any one or more of Examples 36-44 optionally include, wherein the device is a wearable device.

In Example 46, the subject matter of any one or more of Examples 36-45 optionally include, wherein the series of measurements include biometric sensor measurements.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A system for creating a personalized model, the system comprising:
processing circuitry to:
receive a series of measurements from a device;
compare stored measurements to the series of measurements at a predefined feature to determine a subset of the stored measurements, the subset of the stored measurements matching the series of measurements within a tolerance margin; and
build a personalized model for the device using the subset of the stored measurements.

2. The system of claim 1, wherein to build the personalized model, the processing circuitry is to use the series of measurements.

3. The system of claim 1, wherein the processing circuitry is to validate the personalized model using the series of measurements.

4. The system of claim 1, wherein the processing circuitry is to determine the predefined feature using the stored measurements.

5. The system of claim 4, wherein the processing circuitry is to create a plurality of models corresponding to devices used to generate the stored measurements, and wherein to determine the predefined feature includes using the plurality of models.

6. The system of claim 1, wherein the processing circuitry is to send the personalized model to the device.

7. The system of claim 1, wherein the processing circuitry is to:
receive a second series of measurements from the device;
compare the stored measurements to a combination of the series of measurements and the second series of measurements at the predefined feature to determine a second subset of the stored measurements; and
build a second personalized model using the second subset of the stored measurements.

8. The system of claim 7, wherein the processing circuitry is to determine that the second personalized model is more accurate than the personalized model, and send the second personalized model to the device to replace the personalized model.

9. The system of claim 7, wherein the processing circuitry is to iteratively receive measurements from the device, compare the stored measurements to received measurements, build a new personalized model, and send the new personalized model to the device to replace a previous personalized model when the new personalized model is more accurate than the previous personalized model.

10. The system of claim 1, wherein the device is a wearable device.

11. The system of claim 1, wherein the series of measurements include biometric sensor measurements.

12. A method for creating a personalized model, the method comprising:
receiving, at a server, a series of measurements from a device;
comparing stored measurements to the series of measurements at a predefined feature to determine a subset of the stored measurements, the subset of the stored measurements matching the series of measurements within a tolerance margin; and
building a personalized model for the device using the subset of the stored measurements.

13. The method of claim 12, wherein building the personalized model includes using the series of measurements.

14. The method of claim 12, further comprising validating the personalized model using the series of measurements.

15. The method of claim 12, further comprising determining the predefined feature using the stored measurements.

16. The method of claim 15, further comprising creating a plurality of models corresponding to devices used to generate the stored measurements, and wherein determining the predefined feature includes using the plurality of models.

17. The method of claim 12, further comprising sending the personalized model to the device.

18. The method of claim 12, further comprising:
receiving a second series of measurements from the device;
comparing the stored measurements to a combination of the series of measurements and the second series of measurements at the predefined feature to determine a second subset of the stored measurements; and
building a second personalized model using the second subset of the stored measurements.

19. The method of claim 18, further comprising determining that the second personalized model is more accurate than the personalized model, and sending the second personalized model to the device to replace the personalized model.

20. The method of claim 18, further comprising iteratively receiving measurements from the device, comparing the stored measurements to received measurements, building a new personalized model, and sending the new personalized model to the device to replace a previous personalized model, when the new personalized model is more accurate than the previous personalized model.

21. The method of claim 12, wherein the device is a wearable device.

22. The method of claim 12, wherein the series of measurements include biometric sensor measurements.

23. At least one machine-readable medium including instructions for operation of a computing system, which when executed by a machine, cause the machine to perform operations comprising:
receiving a series of measurements from a device;
comparing stored measurements to the series of measurements at a predefined feature to determine a subset of the stored measurements, the subset of the stored measurements matching the series of measurements within a tolerance margin; and
building a personalized model for the device using the subset of the stored measurements.

24. The at least one machine-readable medium of claim 23, wherein building the personalized model includes using the series of measurements.

25. The at least one machine-readable medium of claim 23, further comprising validating the personalized model using the series of measurements.
